(19) United States
(12) Patent Application Publication
(10) Pub. No.: US 2026/0048569 A1
(43) Pub. Date: Feb. 19, 2026

(54) MULTILAYER COMPOSITE THERMALLY-CONDUCTIVE SHEET AND PREPARATION METHOD THEREFOR AND USE THEREOF

(71) Applicant: SHENZHEN HFC CO., LTD., Shenzhen (CN)

(72) Inventors: Jianan Zhang, Shenzhen (CN); Yong Cao, Shenzhen (CN); Jinming Liu, Shenzhen (CN); Aixiang Sun, Shenzhen (CN)

(73) Assignee: SHENZHEN HFC CO., LTD., Shenzhen (CN)

(21) Appl. No.: 19/036,452

(22) Filed: Jan. 24, 2025

(30) Foreign Application Priority Data
Aug. 15, 2024 (CN) 2024111213518

(51) Int. Cl. B32B 15/01; B32B 15/20; C22C 28/00

(52) U.S. Cl. CPC B32B 15/01; B32B 15/20; C22C 28/00; B32B 2307/302; B32B 2307/7376

(57) ABSTRACT

A multilayer composite thermally-conductive sheet, a preparation method therefor and use thereof are provided. The multilayer composite thermally-conductive sheet includes a metal foil, two transition layers provided on two opposite side surfaces of the metal foil, and two low-temperature alloy layers respectively provided on surfaces of the transition layers facing away from the metal foil, wherein the metal foil is made from at least one of silver, copper, zinc, and platinum, the transition layers are made from either indium or tin, the transition layers have a thickness of 5-13 μm; and a melting point of the low-temperature alloy layers is 30-300° C.

### CROSS-REFERENCE TO RELATED APPLICATION

The present disclosure claims the priority to the Chinese patent application with the filing No. 2024111213518 filed with the Chinese Patent Office on Aug. 15, 2024, and entitled “MULTILAYER COMPOSITE THERMALLY-CONDUCTIVE SHEET AND PREPARATION METHOD THEREFOR AND USE THEREOF”, the contents of which are incorporated herein by reference in entirety.

### TECHNICAL FIELD

The present disclosure relates to the technical field of thermally conductive materials, and particularly to a multilayer composite thermally-conductive sheet and a preparation method therefor and use thereof.

### BACKGROUND ART

As a novel thermally conductive interface material, liquid metal is used to solve the heat dissipation problem of electronic devices due to its low thermal resistance and high thermal conductivity. As the liquid metal has fluidity, there is a problem of leakage during application at present. Although a method of providing a circle of foam around an electronic device (such as a chip) for blocking can prevent, to some extent, a short-circuit risk caused by overflow of the liquid metal, in this method, on the one hand, additional costs are increased, and a considerable volume is occupied, and on the other hand, as a gap exists between the foam and a surface of the chip, overflow of the liquid metal cannot be completely blocked, it is still possible to cause occurrence of problems such as voids and vertical flowing of the liquid metal after phase-change melting, thus greatly affecting thermally conductive performance of a product.

In existing researches, by spraying the liquid metal onto an indium layer surface to make a thermally-conductive sheet of a multilayer structure, the above problem of leakage of the liquid metal can be solved to some extent. However, the structure is usually complex, and configuration of the multilayer structure instead increases thermal contact resistance, and the thermally conductive performance of the whole product has not yet been effectively improved.

### SUMMARY

In view of the defects in the prior art, objectives of embodiments of the present disclosure include providing a multilayer composite thermally-conductive sheet, a preparation method therefor and use thereof, so as to improve thermally conductive performance of the thermally-conductive sheet while solving the problems such as leakage, voids and vertical flowing generated after phase change of the liquid metal.

In the first aspect, embodiments of the present disclosure provide a multilayer composite thermally-conductive sheet, including a metal foil, two transition layers respectively provided on two opposite side surfaces of the metal foil, and two low-temperature alloy layers respectively provided on surfaces of the transition layers facing away from the metal foil. In the above, the metal foil is made from at least one of silver, copper, zinc, and platinum; the transition layers are made from either indium or tin, and the transition layers have a thickness of 5-13 μm; and using GB/T 9286-1998 test standard, adhesion of the transition layers to the surfaces of the metal foil is of grade 0, i.e., the highest grade. A melting point of the low-temperature alloy layers is 30-300° C.

In the present disclosure, the metal foil is taken as a central base layer, the transition layers are provided on the surfaces of the metal foil, the low-temperature alloy layers are provided on the surfaces of the transition layers, so that when the low-temperature alloy layers undergo phase-change melting, the transition layers can react with a liquid metal and quickly form an alloy, so as to overcome problems such as liquid metal leakage, vertical flowing, and voids. Moreover, by controlling compositions, a small thickness, and the highest grade of adhesion, the transition layers can stably connect the metal foil and the low-temperature alloy layers, which can improve the adhesion between the transition layers and the metal foil and between the transition layers and the low-temperature alloy layers, can reduce thermal contact resistance between layers of different materials, and ensure integrity and stability of whole structure. Simple structural cooperation between the metal foil, the transition layers and the low-temperature alloy layers makes the multilayer composite thermally-conductive sheet have excellent thermally conductive performance, a thermal conductivity coefficient of not lower than 25 W/m·K, and thermal resistance of not higher than 0.025 cm². K/W.

In some embodiments of the present disclosure, mass parts of various components in the low-temperature alloy layers are: 45-70 parts of In, 20-40 parts of Bi, 5-20 parts of Sn, and 0-15 parts of Ga. More preferably, the low-temperature alloy layers are made from quaternary alloy In₅₁Bi_{30.5}Sn_{15.5}Ga₃.

In some embodiments of the present disclosure, the transition layers have a thickness of 6-8 μm.

In some embodiments of the present disclosure, the metal foil has a thickness of 0.01-0.5 mm.

In some embodiments of the present disclosure, the low-temperature alloy layers have a thickness of 5-40 μm.

In the second aspect, embodiments of the present disclosure provide a preparation method for the above multilayer composite thermally-conductive sheet, including steps of: forming the transition layers on two opposite surfaces of the metal foil, respectively; and

spraying a liquid metal on a surface of each of the transition layers facing away from the metal foil, so as to form the low-temperature alloy layers.

In some embodiments of the present disclosure, the step of “forming the transition layers on two opposite surfaces of the metal foil respectively” specifically includes:

forming the transition layers respectively on the two opposite surfaces of the metal foil by means of electroplating or magnetron sputtering.

The electroplating or magnetron sputtering can further improve the adhesion of the transition layers on the surfaces of the metal foil, so that they are stably connected, and the transition layers are dense and uniform, thus effectively reducing interface thermal resistance between the transition layers and the metal foil.

In some embodiments of the present disclosure, a step of the electroplating specifically includes:

immersing the metal foil into an electroplating solution, and electroplating the surfaces of the metal foil so as to form the transition layers, wherein the electroplating solution includes an anionic surfactant and a nonionic surfactant.

In the third aspect, the present disclosure further provides use of the above multilayer composite thermally-conductive sheet, which, for example, may be used for heat dissipation of electronic components.

### BRIEF DESCRIPTION OF DRAWINGS

In order to more clearly illustrate technical solutions of embodiments of the present disclosure, drawings which need to be used in the embodiments will be briefly introduced below. It should be understood that the drawings merely show some embodiments of the present disclosure, and thus should not be considered as limitation to the scope. Those ordinarily skilled in the art still could obtain other relevant drawings according to these drawings, without using any inventive efforts.

FIG. 1 is a structural schematic diagram of a multilayer composite thermally-conductive sheet of the present disclosure;

FIG. 2 is a state diagram of a multilayer composite thermally-conductive sheet according to Example 1 of the present disclosure after thermal resistance test;

FIG. 3 is a state diagram of the multilayer composite thermally-conductive sheet according to Example 1 of the present disclosure after a vertical flowing test at 125° C. for 500 h;

FIG. 4 is a state diagram of the multilayer composite thermally-conductive sheet according to Example 1 of the present disclosure after a vertical flowing test at 125° C. for 1000 h;

FIG. 5 is a diagram of adhesion test result in Example 1 of the present disclosure; and

FIG. 6 is a diagram of adhesion test result in Comparative Example 4 of the present disclosure.

Reference signs: 10-metal foil; 20-transistion layer; 30-low-temperature alloy layer; 100-multilayer composite thermally-conductive sheet.

### DETAILED DESCRIPTION OF EXAMPLES

In order to make objectives, technical solutions and advantages of embodiments of the present disclosure clearer, the technical solutions in the embodiments of the present disclosure will be described below clearly and completely. Embodiments, for which no concrete conditions are specified, are performed according to conventional conditions or conditions recommended by manufactures. Where manufacturers of reagents or apparatuses used are not specified, they are conventional products commercially available.

A multilayer composite thermally-conductive sheet, a preparation method therefor and use thereof according to embodiments of the present disclosure will be described in detail below.

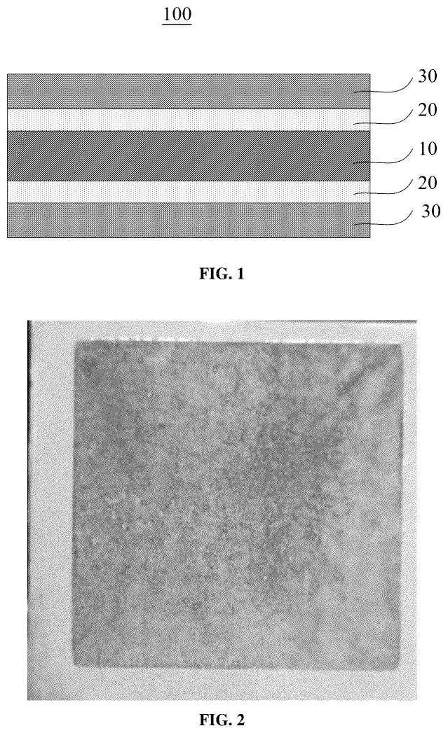

Referring to FIG. 1, embodiments of the present disclosure provide a multilayer composite thermally-conductive sheet 100, including a metal foil 10, two transition layers 20 provided on two opposite side surfaces of the metal foil 10, and two low-temperature alloy layers 30 provided on surfaces of the transition layers 20 facing away from the metal foil 10. In the above, the metal foil 10 is made from at least one of silver, copper, zinc, and platinum; the transition layers 20 are made from either indium or tin, and the transition layers 20 have a thickness of 5-13 μm; and using GB/T 9286-1998 test standard, adhesion of the transition layers to the surfaces of the metal foil is of grade 0. A melting point of the low-temperature alloy layers 30 is 30-300° C.

Those skilled in the art could know that in a multilayer composite structure, interface thermal resistance difference is present between different material layers, and different 4360 PAUS-5-materials have different thermal conductivities, and different transmission rates of phonons; therefore, the greater the number of layers is, the worse the corresponding thermal resistance performance is. The multilayer composite thermally-conductive sheet 100 in the present disclosure is of a simple five-layer structure, including three materials: the metal foil 10, the transition layers 20 and the low-temperature alloy layers 30, where the metal foil 10, as a central base layer, not only has an excellent thermally conductive performance, but also has high strength and flexibility, and simultaneously can function as a product skeleton and have high heat conduction; indium or tin layers, as the transition layers 20, connect the metal foil 10 and the low-temperature alloy layers 30, so that the transition layers 20 can be combined with a liquid metal melting on surfaces, and quickly absorb the liquid metal on the surfaces to prevent overflow and leakage. By controlling the transition layers 20 to have the highest grade of adhesion and a small thickness, the transition layers can be tightly attached to the metal foil 10 on the basis of ensuring complete adsorption of the liquid metal on the surfaces, so that the thermal contact resistance between different materials can be reduced, and various layers will not peel off from each other, thereby ensuring stability of the whole structure.

In the present disclosure, the low-temperature alloy layers 30, with a melting point of 30-300° C., are in a solid state at a room temperature, and undergo phase change melting when being heated (for example, at 50-70° C.), where a part of the melted low-temperature alloy layers fill gaps of thermal interfaces, for example, micro-undulations and slits between a chip and a heat dissipation module, which brings about extremely low thermal resistance, thereby playing a role of “thermal interface material”; and the other part can rapidly react and merge with the transition layers 20 to form a new alloy, so that overflow and leakage can be prevented.

In the present disclosure, the metal foil, the transition layers and the low-temperature alloy layers cooperate with each other so as to ensure integrity and stability of the multilayer composite thermally-conductive sheet. In normal operation of devices whose heat is to be dissipated, the whole thermally-conductive sheet presents a solid state (a liquid-free state), so that important key defects such as flowing and vertical flowing of the liquid metal are effectively solved, and at the same time, the thermally conductive performance of the whole structure is effectively improved. The multilayer composite thermally-conductive sheet has a 4360 PAUS-6-thermal conductivity coefficient of not lower than 25 W/m·K, and thermal resistance of not higher than 0.025 cm². K/W. In a preferred condition, the thermal conductivity coefficient of the multilayer composite thermally-conductive sheet 100 can be up to 32.5 W/m·K, and the thermal resistance is as low as 0.007 cm². K/W.

It can be understood that the low-temperature alloy mentioned in the present disclosure refers to low-melting-point alloy, preferably having a melting point of 30-130° C., and usually composed of In, Bi, Sn and like low-melting-point metal elements. In some embodiments, mass parts of various components in the low-temperature alloy layers may be: 50-70 parts of In, 20-40 parts of Bi, 5-20 parts of Sn, and 0-15 parts of Ga, specifically quaternary alloys such as In₅₁Bi_{30.5}Sn_{15.5}Ga₃, In₆₃Bi₂₀Sn₁₀Ga₇, and In₄₉Bi₂₈Sn₁₁Ga₁₂.

Preferably, the low-temperature alloy layers are made from quaternary alloy In₅₁Bi_{30.5}Sn_{15.5}Ga₃, and the transition layers are made from indium, so that the low-temperature alloy layers can be well combined with the indium layers.

In the above, the higher the mass parts of gallium is, the greater the corrosivity thereof is, the lower the melting point of the formed liquid alloy is, the higher the fluidity is, and the worse the stability of the multilayer composite thermally-conductive sheet prepared is.

In some embodiments, the metal foil has a thickness of 0.01-0.5 mm. The metal foil has high thermal conductivity (for example, thermal conductivity of a copper sheet is up to 400 W) and high strength. The smaller the thickness is, the lower the thermal resistance is, but too small thickness will also cause presence of residual stress inside to make the surface not very flat (e.g., copper has poor plasticity).

In some embodiments, a thickness of the transition layer may be 6-8 μm, and specifically may be 6 μm, 6.3 μm, 6.2 μm, 5.5 μm, etc. The thermally conductive performance of the transition layers is worse than that of the metal foil, for example, the thermal conductivity of the indium sheet is only 80 W, a too small thickness will cause it unable to completely absorb the liquid metal on the surfaces, an excessive thickness will affect the thermally conductive performance, and adhesive strength and uniformity thereof on the metal foil will also affect the thermal stability and thermal contact resistance of the whole thermally-conductive sheet.

In some embodiments, a thickness of the low-temperature alloy layers is 5-40 μm, and specifically may be 20 μm, 40 μm, 5 μm, etc. While filling the slits, the low-temperature alloy layers need to merge with the transition layers to form a high-melting-point alloy, so as to ensure that the low-temperature alloy in a molten state will not overflow and flow out. Therefore, too thick low-temperature alloy layers will cause redundant liquid molten metal to overflow and leak out, and too thin low-temperature alloy layers will lead to poor slit filling effect and result in unfavorable thermally conductive performance.

Correspondingly, the present disclosure further provides a preparation method for the above multilayer composite thermally-conductive sheet, including following steps:
forming the transition layers on two opposite surfaces of the metal foil respectively; and
spraying a liquid metal on a surface of each of the transition layers facing away from the metal foil, so as to form the low-temperature alloy layers.

In the above, the transition layers are formed respectively on the two opposite surfaces of the metal foil by means of electroplating or magnetron sputtering.

The transition layers are formed by means of electroplating or magnetron sputtering rather than rolling and coating, so that the transition layers are distributed densely and uniformly on the surfaces of the metal foil, which ensures that the adhesion can reach grade 0 on the basis of an extremely small thickness, so that the thermal contact resistance of interfaces of different materials can be reduced, and stability of the whole structure can be ensured. As an oxide film often exists on a surface of a metal foil, when the conventional calendering or applying/coating method is used, the transition layers cannot be well combined with the metal foil, which will result in extremely high thermal contact resistance therebetween. Furthermore, the liquid metal alloy with a low melting point belongs to an intermetallic compound, and has higher hardness and greater brittleness than pure metal, and if the adhesion is insufficient, the liquid metal in an unmelted state will peel off the transition layers from the surfaces of the metal foil.

Specifically, an electroplating method adopted includes following steps:
immersing the metal foil into an electroplating solution, and energizing for a period of time to electroplate two opposite surfaces of the metal foil so as to form the transition layers, where the electroplating solution includes an anionic surfactant and a nonionic surfactant. The anionic surfactant may be sodium dodecylsulfate, and the nonionic surfactant may be polyethylene glycol trimethylnonyl ether. The anionic surfactant and the nonionic surfactant can enhance the adhesion, uniformity and purity of a plating layer on a to-be-plated layer.

It can be understood that the electroplating solution further includes an indium ion or a tin ion, such as indium sulfate or tin sulfate. In some embodiments, the electroplating solution further includes sodium hydroxide for adjusting pH.

In addition, the present disclosure further provides use of the above multilayer composite thermally-conductive sheet, which, for example, can be used for heat dissipation of electronic components. In the above, the electronic components may be, for example, but not limited to, chips or heat dissipaters.

The features and performances of the present disclosure are further described in detail below in conjunction with examples.

### Example 1

The present example provided a multilayer composite thermally-conductive sheet, where a metal foil was a copper sheet, transition layers were indium layers, and low-temperature alloy layers were of quaternary alloy In₅₁Bi_{30.5}Sn_{15.5}Ga₃. The multilayer composite thermally-conductive sheet was prepared by a method as follows.
(1) A copper foil was made into a metal foil with a thickness of 0.05 mm by means of calendering.
(2) The above metal foil was electrodeposited with indium in an electroplating solution, where a current density was 1 A/m², after energization for 2 h, the metal foil was dried, and transition layers were formed respectively on two opposite side surfaces of the metal foil, where the electroplating solution included dilute sulfuric acid, indium sulfate, dilute sulfuric acid, sodium dodecylsulfate, polyethylene glycol trimethylnonyl ether and sodium hydroxide.
(3) 4 N of pure indium granules, bismuth granules, tin granules, and gallium granules were taken as raw materials of the low-temperature alloy layers, where a mass fraction ratio of the indium granules, bismuth granules, tin granules to gallium granules was 51:30.5:15.5:3; the raw materials weighed in proportion were put into a vacuum medium-frequency smelting furnace, vacuumized and heated to 400° C., maintained for 2 h and taken out, stirred in a vacuum heating stirrer at a temperature kept at 80° C., at a rate of 400 rad/min for 30 min, to make liquid metals to be well mixed, and render quaternary alloy In₅₁Bi_{30.5}Sn_{5.5}Ga₃ with a melting point of 55-60° C.
(4) The well mixed liquid metals were poured into a mechanical pump to be heated, where the mechanical pump was connected to a heating pipe, and the heating pipe was connected to a heating spray head. An overall temperature was maintained at 120° C. The mechanical pump was started to pump the liquid metals into a spraying pipe to spray. The liquid metals were sprayed in a required area by setting a movement direction of the spray head. A servo motor was adjusted to control a spraying velocity to be 200 mm/c. A heat dissipation module to be sprayed was placed below the spray head, the spray head was 30 cm away from a sprayed surface. Liquid metal mist was uniformly sprayed on surfaces of the transition layers to form the low-temperature alloy layers with a thickness of 20 μm. Upon cooling and shaping, the multilayer composite thermally-conductive sheet was obtained.

### Example 2

The preparation method in the present example was substantially the same as that in Example 1, and was merely different in that:
the thickness of the metal foil in step (1) was 0.1 mm.

### Example 3

The preparation method in the present example was substantially the same as that in Example 1, and was merely different in that:
the thickness of the metal foil in step (1) was 0.2 mm.

### Example 4

The preparation method in the present example was substantially the same as that in Example 1, and was merely different in that:
the thickness of the metal foil in step (1) was 0.01 mm.

### Example 5

The preparation method in the present example was substantially the same as that in Example 1, and was merely different in that:
in step (3), 4 N of pure indium granules, bismuth granules, tin granules, and gallium granules were taken as the raw materials of the liquid metals, the mass fraction ratio was 63:20:10:7, and the melting point of quaternary alloy In₆₃Bi₂₀Sn₁₀Ga₇ obtained was 45-50° C.

### Example 6

The preparation method in the present example was substantially the same as that in Example 1, and was merely different in that:
in step (3), 4 N of pure indium granules, bismuth granules, tin granules, and gallium granules were taken as raw materials in the liquid metal, the mass fraction ratio was 49:28:11:12, and the melting point of quaternary alloy In₄₉Bi₂₈Sn₁₁Ga₁₂ obtained was 45-50° C.

### Example 7

The preparation method in the present example was substantially the same as that in Example 1, and was merely different in that:
the thickness of the low-temperature alloy layers sprayed in step (4) was 5 μm.

### Example 8

The preparation method in the present example was substantially the same as that in Example 1, and was merely different in that:
the thickness of the low-temperature alloy layers sprayed in step (4) was 40 μm.

### Example 9

The preparation method in the present example was substantially the same as that in Example 1, and was merely different in that:
an energizing period in step (2) was 4 h.

### Comparative Example 1

The preparation method in the present comparative example was substantially the same as that in Example 1, and was merely different in that:
an energizing period in step (2) was 5 h.

### Comparative Example 2

The preparation method in the present comparative example was substantially the same as that in Example 1, and was merely different in that:
an energizing period in step (2) was 0.5 h.

### Comparative Example 3

The preparation method in the present comparative example was substantially the same as that in Example 1, and was merely different in that:
in step (2), indium sheets were rolled to the metal foil, so as to render the transition layers with a thickness of 6 μm.

### Comparative Example 4

The preparation method in the present comparative example was substantially the same as that in Example 1, and was merely different in that:
in step (2), a layer of molten indium was coated on surfaces of the metal foil, so as to render indium layers with a thickness of 6 μm after drying.

The multilayer composite thermally-conductive sheets prepared in Examples 1-8 and Comparative Examples 1˜4 were tested for performances, and methods for testing various performances were as follows.
(1) Thermal conductivity coefficient/thermal resistance: tested by a thermal conductivity coefficient tester (Model: Longwin 9389) from Taiwan Long Win, with test parameters of 50 psi, 80° C., and 20 min.
(2) Vertical flowing: the multilayer composite thermally-conductive sheets were vertically placed in an oven at 125° C. for 500 h and 1,000 h.
(3) Adhesion: after the transition layers were formed on the metal foil, samples were selected to test the adhesion of the transition layers on the metal foil according to GBT9286-1998 test standard. According to test results, the adhesion was divided into six grades from 0 to 5, and evaluation criteria corresponding to each grade were as follows:
Grade 0: cut edge was completely smooth and no lattice fell off;
Grade 1: a little coating fell off at intersection of cuts, but cross-cut area affected should not be obviously greater than 5%;
Grade 2: coating fell off at intersection of cuts and/or along edge of cuts, cross-cut area affected was obviously greater than 5%, but should not be obviously greater than 15%;
Grade 3: coating partially or completely fell off with broken pieces along cut edge, and/or partially or completely fell off from different parts of lattices, and cross-cut area affected was obviously greater than 15%, but should not be obviously greater than 35%;
Grade 4: coating peeled off with large broken pieces along cut edge, and/or some squares partially or completely peeled off, and cross-cut area affected was obviously greater than 35%, but should not be obviously greater than 65%; and
Grade 5: degree of peeling off exceeded grade 4.

Results of the above performances tests are shown in TABLE 1.

TABLE 1
Thicknesses of Transition Layers and Performances of
Corresponding Multilayer Composite Thermally-Conductive
Sheets in Examples and Comparative Examples

| | Thermal | | | |
|---|---|---|---|---|
| | Conductivity | Thermal | Thickness of | |
| | Coefficient | Resistance | Transition Layer | Adhesion |
| Group | (W/m · K) | (cm² · K/W) | (μm) | Grade |
| Example 1 | 32.5 | 0.007 | 6 | 0 |
| Example 2 | 29.4 | 0.017 | 6.3 | 0 |
| Example 3 | 28.8 | 0.021 | 6.2 | 0 |
| Example 4 | 27.5 | 0.012 | 5.5 | 0 |
| Example 5 | 26.8 | 0.022 | 6 | 0 |
| Example 6 | 29 | 0.018 | 6.2 | 0 |
| Example 7 | 26 | 0.024 | 6.2 | 0 |
| Example 8 | 29.5 | 0.017 | 6 | 0 |
| Example 9 | 25 | 0.025 | 12 | 0 |
| Comparative | 21.2 | 0.041 | 20 | 1 |
| Example 1 | | | | |
| Comparative | 22.7 | 0.033 | 2 | 1 |
| Example 2 | | | | |
| Comparative | 18 | 0.06 | 6 | 4 |
| Example 3 | | | | |
| Comparative | 19.2 | 0.057 | 6 | 3 |
| Example 4 | | | | |

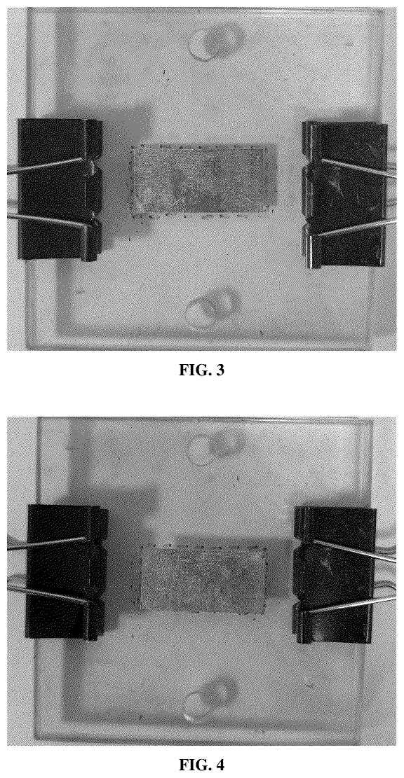

By comparing the test results of the performances in TABLE 1, it can be seen that the heat conductivity coefficients of the multilayer composite thermally-conductive sheets prepared in Examples 1-9 are all not lower than 25 W/m·K, and the thermal resistance is not higher than 0.025 cm². K/W. By combining the test results in FIG. 2, FIG. 3 and FIG. 4, it can be seen that products do not have vertical flowing, deformation or overflowing. It can be seen from comparison between the test results of Comparative Examples 1 and 2 and Example 1 that too thick or too thin transition layers will affect the thermally conductive performance of final thermally-conductive sheet, and the adhesion grade will also be reduced.

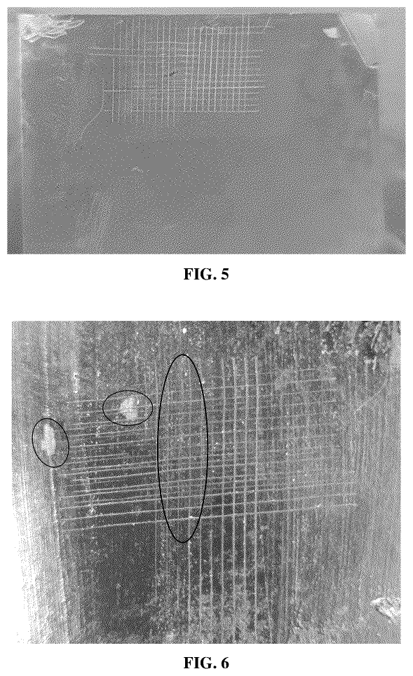

It can be seen from comparison between the test results of Comparative Examples 3 and 4 and Example 1 that the transition layers are formed by means of electroplating in Example 1, it can be seen from the test results of adhesion of FIG. 5 that a cut surface of the transition layer is smooth, after an adhesive tape is torn off, no lattice falls off, the adhesion grade is grade 0, corresponding thermal conductivity coefficient is up to 32.5 W/m·K, and the thermal resistance is as low as 0.007 cm². K/W. However, in Comparative Examples 3 and 4, the transition layers formed by rolling or coating have poor uniformity, and the adhesion of the transition layers on the surfaces of the metal foil is remarkably reduced. It can be seen from the state diagram of FIG. 6 of Comparative Example 4 after the adhesion test that regions circled in the drawing have fallen off. Furthermore, insufficient adhesion will result in formation of an oxide layer on the surface of the metal foil, thus affecting a heat conduction path (thermally conductive performance of the oxide layer is ten or tens of times inferior to that of pure metal), and the thermally conductive performance of the whole thermally-conductive sheet is degraded.

Only some but not all examples of the present disclosure are described in the above. The detailed description of the examples of the present disclosure is not intended to limit the scope of the present disclosure claimed, but merely illustrates chosen examples of the present disclosure. All of other examples obtained by those ordinarily skilled in the art based on the examples in the present disclosure without using any inventive efforts shall fall within the scope of protection of the present disclosure.

What is claimed is:

1. A multilayer composite thermally-conductive sheet, comprising a metal foil, two transition layers respectively provided on two opposite surfaces of the metal foil, and two low-temperature alloy layers respectively provided on surfaces of the transition layers facing away from the metal foil,
wherein the metal foil is made from at least one selected from the group consisting of silver, copper, zinc, and platinum;
the transition layers are made from one selected from the group consisting of indium and tin, and the transition layers have a thickness of 5-13 μm; and using GB/T 9286-1998 test standard, adhesion of the transition layers to the surfaces of the metal foil is of grade 0; and
a melting point of the low-temperature alloy layers is 30-300° C.

2. The multilayer composite thermally-conductive sheet according to claim 1, wherein mass parts of various components in the low-temperature alloy layers are: 45-70 parts of In, 20-40 parts of Bi, 5-20 parts of Sn, and 0-15 parts of Ga.

3. The multilayer composite thermally-conductive sheet according to claim 2, wherein the low-temperature alloy layers are made from quaternary alloy In₅₁Bi_{30.5}Sn_{15.5}Ga₃.

4. The multilayer composite thermally-conductive sheet according to claim 1, wherein the transition layers have a thickness of 6-8 μm.

5. The multilayer composite thermally-conductive sheet according to claim 1, wherein the metal foil has a thickness of 0.01-0.5 mm.

6. The multilayer composite thermally-conductive sheet according to claim 1, wherein the low-temperature alloy layers have a thickness of 5-40 μm.

7. A preparation method for the multilayer composite thermally-conductive sheet according to claim 1, comprising steps of:
forming the transition layers on two opposite surfaces of the metal foil respectively; and
spraying a liquid metal on surfaces of the transition layers facing away from the metal foil, so as to form the low-temperature alloy layers.

8. The preparation method according to claim 7, wherein the step of forming the transition layers on two opposite surfaces of the metal foil respectively comprises:
forming the transition layers respectively on the two opposite surfaces of the metal foil by electroplating or magnetron sputtering.

9. The preparation method according to claim 8, wherein a step of the electroplating comprises:
immersing the metal foil into an electroplating solution, and electroplating two opposite surfaces of the metal foil so as to form the transition layers, wherein the electroplating solution comprises an anionic surfactant and a nonionic surfactant.

10. The preparation method according to claim 7, wherein mass parts of various components in the low-temperature alloy layers are: 45-70 parts of In, 20-40 parts of Bi, 5-20 parts of Sn, and 0-15 parts of Ga.

11. The preparation method according to claim 10, wherein the low-temperature alloy layers are made from quaternary alloy In₅₁Bi_{30.5}Sn_{15.5}Ga₃.

12. The preparation method according to claim 7, wherein the transition layers have a thickness of 6-8 μm.

13. The preparation method according to claim 7, wherein the metal foil has a thickness of 0.01-0.5 mm.

14. The preparation method according to claim 7, wherein the low-temperature alloy layers have a thickness of 5-40 μm.
